(19) United States
(12) Patent Application Publication
(10) Pub. No.: US 2004/0047519 A1
(43) Pub. Date: Mar. 11, 2004

(54) Dynamic image repurposing apparatus and method

(75) Inventors: Benoit Gennart, Lausanne (CH); Gregory Casey, Annapolis, MD (US)

Correspondence Address: John F. Nethery, SONNENSCHEN NATH & ROSENTHAL, P.O. Box #061080, Wacker Drive Station, Sears Tower, Chicago, IL, 60606-1080, US

(73) Assignee: AXS TECHNOLOGIES

(21) Appl. No.: 10/235,573

(22) Filed: Sep. 5, 2002

(51) Int. Cl. G06K 9/32

(52) U.S. Cl. 382/298

(57) ABSTRACT

Methods and systems provide image generation without requiring excessive amounts of processing or storage. The methods and systems may dynamically generate an output image in any of numerous combinations of resolution, size, image coding format, color coding format, and the like based on a multi-resolution representation of an original image. As a result, the methods and systems flexibly generate output images while consuming less computational and storage resources than prior techniques.

### FIELD OF THE INVENTION

This invention relates to image processing. In particular, this invention relates to dynamically generating an image from a single source in one of numerous possible output coding formats, color code formats, sizes, and resolutions without incurring immense storage and computation penalties.

### BACKGROUND OF THE INVENTION

Rapid growth in computer processing power coupled with enormous increases in the capacity of data storage devices have enabled the widespread use of computer graphics in innumerable applications. Attendant with such growth, however, has come an immense variety of image coding formats as well as color coding formats. Each image coding format provides a specification for representing an image as a series of data bits. A few examples of widely used image coding formats include the Joint Photographics Experts Group jpeg) format, the Graphics Interchange Format (gif), the Tagged Image File Format (tiff), the Encapsulated Postscript (eps) format, and the Windows Bitmap (bmp) format. Each color coding format provides a specification for how the data bits represent color information. Examples of color coding formats include Red Green Blue (RGB), Cyan Magenta Yellow Key (CMYK), and the CIE L-channel A-channel B-channel Color Space (LAB).

Due in part to the large number of image encoding formats and color coding formats, it is impractical for individual software applications to include the program code required to load, manipulate, and store an image in every possible format and combination of formats. As a result, the software applications are very often unable to work with an image simply because it is encoded in a format that the software application does not support. Furthermore, hardware output devices (printers, plotters, and video displays, as examples) often require images to be presented in a particular encoding format, and lack the capability to convert unsupported formats to a supported format.

In addition to a specific encoding format, software and hardware entities often require an image to be presented at a particular resolution. The resolution can vary over extremely wide ranges (for example, from 16×16 pixel thumbnails to 2048×2048 high resolution photos). Coupled with the immense number of encoding formats, a software or hardware entity could require an image to be presented in a staggering number of resolutions and encoding formats.

In the past, providing an image in a wide variety of resolutions and encoding formats for convenient access was extremely computationally intensive and extremely storage intensive. Typically, a series of static image preparation steps were applied to an original image. The steps included loading the original image (in an original encoding format) into memory, resizing the image many times to provide images at the various resolutions that might be needed, applying multiple color coding formats to each resized image, converting the original encoding format to multiple coding formats, and storing each converted image on disk. As a example, given three resolution possibilities, three color coding formats, and three image coding formats, twenty-seven (27) images would be statically precomputed and stored.

However, every resizing operation, color coding operation, and image coding operation consumes valuable processing resources and requires significant amounts of processor time. Furthermore, storing numerous versions of an image (differing in size, color coding, and image coding) consumes significant amounts of storage space. There is also no guarantee that any particular version of an image will ever be used, and the processing and storage resources used to create and store that version are therefore wasted.

Therefore, a need has long existed for methods and apparatus that overcome the problems noted above and others previously experienced.

### SUMMARY OF THE INVENTION

Methods and systems consistent with the present invention provide image generation without requiring excessive amounts of processing or storage. The methods and systems may be used to dynamically generate an output image in any of numerous combinations of resolution, image coding format, color coding format, and the like based on a multi-resolution representation of an image. As a result, the methods and systems may flexibly generate output images while consuming fewer computational and storage resources.

According to one aspect of the present invention, an original image is stored in a multi-resolution representation. The multi-resolution representation may be distributed over multiple disks, or stored on a single disk. Individual output images at a specified resolution, size, color coding, and image coding are dynamically produced from the multi-resolution representation.

Methods and systems consistent with the present invention overcome the shortcomings of the related art, for example, by storing an original image in a multi-resolution representation. As a result, preprocessing time and resources are greatly reduced by dynamically generating an output image starting with the multi-resolution representation, as opposed to pre-generating an immense number of individual image files at different resolutions, image codings, and color codings. Furthermore, the resolution, image coding and color coding combinations are not limited to those produced by preprocessing steps. Rather, the methods and systems are able to generate an output image at virtually any desired resolution, size, image coding, or color coding.

Other apparatus, methods, features and advantages of the present invention will be or will become apparent to one with skill in the art upon examination of the following figures and detailed description. It is intended that all such additional systems, methods, features and advantages be included within this description, be within the scope of the present invention, and be protected by the accompanying drawings.

### BRIEF DESCRIPTION OF THE DRAWINGS

FIG. 1 depicts a block diagram of a data processing system suitable for practicing methods and implementing systems consistent with the present invention.

FIG. 2 shows a flow diagram of pre-processing steps taken before generating images.

FIG. 3 illustrates an example of a multi-resolution representation in which five blocks have been written.

FIG. 4 shows an example of a node/block index allocation for a 1, 2, 3, 4-node file comprises 3×3 image tiles.

FIG. 5 illustrates depicts a flow diagram of steps executed to generate an image.

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts.

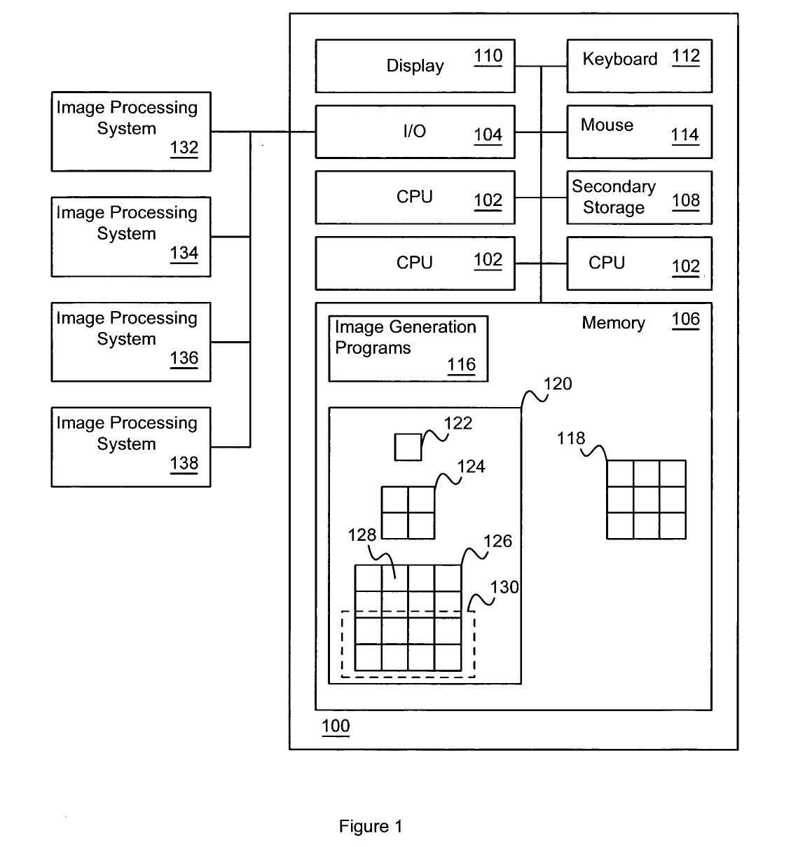

FIG. 1 depicts a block diagram of an image processing system 100 suitable for practicing methods and implementing systems consistent with the present invention. The image processing system 100 comprises at least one central processing unit (CPU) 102 (three are illustrated), an input output I/O unit 104 (e.g., for a network connection), one or more memories 106, one or more secondary storage devices 108, and a video display 110. The data processing system 100 may further include input devices such as a keyboard 112 or a mouse 114. The memory 106 stores one or more instances of an image generation program 116 that generates an output image 118 starting with a multi-resolution representation 120 of an original image.

As will be explained in more detail below, the multi-resolution representation 120 stores multiple image entries (for example, the image entries 122, 124, and 126). The multi-resolution representation 120 may be structured in many different ways, and an exemplary format is given below. In general, each image entry is a version of the original image at a different resolution and each image entry in the multi-resolution representation 120 is generally formed from image tiles 128. The image tiles 128 form horizontal image stripes (for example, the image stripe 130) that are sets of tiles that horizontally span an image entry.

The image processing system 100 may connect to one or more separate image processing system 132-138. For example, the I/O unit 104 may include a WAN/LAN or Internet network adapter to support communications from the image processing system 132 locally or remotely. Thus, the image processing system 132 may take part in generating the output image 118 by generating a portion of the output image 118 based on the multi-resolution representation 120. In general, the image generation techniques explained below may run in parallel on any of the multiple processors 102 and alternatively or additionally separate image processing systems 132-138, and intermediate results (e.g., image stripes) may be combined in whole or in part by any of the multiple processors 102 or separate image processing systems 132-138.

The image processing systems 132-138 may be implemented in the same manner as the image processing 100. Furthermore, as noted above, the image processing systems 132-138 may help generate all of, or portions of the output image 118. Thus, the image generation may not only take place in a multiple-processor shared-memory architecture (e.g., as shown by the image processing system 100), but also in a distributed memory architecture (e.g., including the image processing systems 100 and 132-138). Thus the “image processing system” described below may be regarded as a single machine, multiple machines, or multiple CPUs, memories, and secondary storage devices in combination with a single machine or multiple machines.

In addition, although aspects of the present invention are depicted as being stored in memory 106, one skilled in the art will appreciate that all or part of systems and methods consistent with the present invention may be stored on or read from other computer-readable media, for example, secondary storage devices such as hard disks, floppy disks, and CD-ROMs; a signal received from a network such as the Internet; or other forms of ROM or RAM either currently known or later developed. For example, the multi-resolution representation 120 may be distributed over multiple secondary storage devices. Furthermore, although specific components of the image processing system 100 are described, one skilled in the art will appreciate that an image processing system suitable for use with methods and systems consistent with the present invention may contain additional or different components.

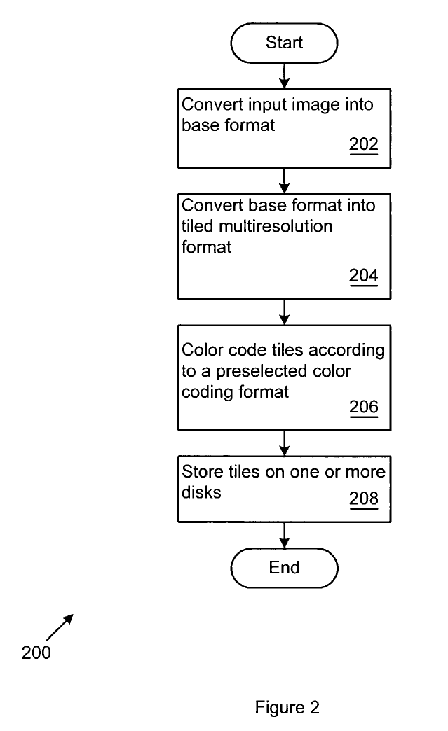

Turning to FIG. 2, that Figure presents a flow diagram of pre-processing steps that generally occur before the image generation program 116 begins to generate output images from the multi-resolution representation 120. The steps shown in FIG. 2 may be performed by any of the image processing systems 100, 132-138, or by any other data processing system.

In particular, the image processing system 100 first converts the original image into a base format. (Step 202). The base format specifies a color coding and an image coding. For example, the base format may be an uncompressed LAB, RGB, or CMYK format stored as a sequence of m-bit (e.g., 8-, 16-, or 24-bit) pixels.

Subsequently, the original image, in its base format, is converted into a tiled multi-resolution representation 120. (Step 204). A detailed discussion is provided below, however, some of the underlying concepts are described at this juncture. The multi-resolution representation 120 includes multiple image entries (e.g., the entries 122, 124, 126), in which each image entry is a different resolution version of the original image. The image entries are comprised of image tiles that generally do not change in size. Thus, as one example, an image tile may be 128 pixels×128 pixels, and an original 1,024 pixel×1,024 pixel image may be formed by 8×8 array of image tiles.

Each image entry in the multi-resolution representation 120 is comprised of image tiles. For example, assume that the multi-resolution representation 120 stores a 1,024×1,024 image entry, a 512×512 image entry, a 256×256 image entry, a 128×128 image entry, and a 64×64 image entry, for example. Then, the 1,024×1,024 image entry is formed from 64 image tiles (e.g., 8 horizontal and 8 vertical image tiles), the 512×512 image entry is formed from 16 image tiles (e.g., 4 horizontal and 4 vertical image tiles), the 256×256 image entry is formed from 4 image tiles (e.g., 2 horizontal and 2 vertical image tiles), the 128×128 image entry is formed from 1 image tile, and the 64×64 image entry is formed from 1 image tile (e.g., with the unused pixels in the image tile let blank, for example).

The number of image entries, their resolutions, and the image tile size may vary widely between original images, and from implementation to implementation. The image tile size, in one embodiment, is chosen so that the transfer time for retrieving the image tile from disk is approximately equal to the disk latency time for accessing the image tile. Thus, the amount of image data in an image tile may be determined approximately by T*L, where T is the throughput of the disk that stores the tile, and L is the latency of the disk that stores the tile. As an example, an 50 KByte image tile may be used with a disk having 5 MBytes/second throughput, T, and a latency, L, of 10 ms.

The multi-resolution representation 120 optimizes out-of-core data handling, in that it supports quickly loading into memory only the part of the data that is required by an application (e g., the image generation program 116). The multi-resolution representation 120 generally, though not necessarily, resides in secondary storage (e.g., hard disk, CD-ROM, or any online persistent storage device), and processors load all or part of the multi-resolution representation 120 into memory before processing the data.

The multi-resolution representation 120 is logically a single file, but internally includes multiple files. Namely, the multi-resolution representation 120 includes a meta-file and one or more nodes. Each node includes an access-file and a data file.

The meta-file includes information specifying the type of data (e.g., 2-D image, 3-D image, audio, video, and the like) stored in the multi-resolution representation 120. The meta-file further includes information on node names, information characterizing the data (e.g., for a 2-D image, the image size, the tile size, the color and image coding, and the compression algorithm used on the tiles), and application specific information such as geo-referencing, data origin, data owner, and the like.

Each node data file includes a header and a list of image tiles referred to as extents. Each node address file includes a header and a list of extent addresses that allowing a program to find and retrieve extents in the data file.

The meta-file, in one implementation, has the format shown in Table 1 for an exemplary file ila0056e.axf:

| Line | Entry | Explanation |
|---|---|---|
| 1 | [AxsFile] | Identifies file type |
| 2 | Content = Image | Identifies file content as an image |
| 3 | Version = 1.0 | This is version 1 of the image |
| 4 | | |
| 5 | [Nodes] | There is one node |
| 6 | localhost \| \| ila0056e.axf | Node is stored on local host and |
| | | named ila0056e.axf |
| 7 | | |
| 8 | [Extentual] | |
| 9 | Height = 128 | Tile height |
| 10 | Width = 128 | Tile width |
| 11 | | |
| 12 | [Size] | |
| 13 | Height = 2048 | Image height, at highest resolution |
| 14 | Width = 2560 | Image width, at highest resolution |
| 15 | | |
| 16 | [Pixual] | |
| 17 | Bits = 24 | Bits pet pixel |
| 18 | RodCone = Color | Color image |
| 19 | Space = RGB | Color coding, red, green, blue color |
| | | channels |
| 20 | Mempatch = Interlace | Channels are interleaved |
| 21 | | |
| 22 | [Codec] | |
| 23 | Method = Jpeg | Image coding |

In alternate embodiments, the meta-file may be set forth in the X11 parameterization format, or the eXtensible Markup Language (XML) format. The content is generally the same, but the format adheres to the selected standard. The XML format, in particular, allows other applications to easily search for and retrieve information retained in the meta-file.

For a 2-D image, the meta-file may further include, for example, the following information shown in Table 2. Note that the pixel description is based on four attributes: the rod-cone, the color-space, bits-per-channel, and number-of-channels. The various options for the pixel-descriptions are: (1) rodcone: blind, onebitblack, onebitwhite, gray, idcolor, and color and (2) colorspace: Etheral, RGB, BGR, RGBA, ABGR, CMYK, LAB, Spectral. In the case where the number of channels is greater than one, the channels may be interleaved or separated in the multi-resolution representation 120.

TABLE 2
Equivalence Table

| | | | | Number of |
|---|---|---|---|---|
| Image | Rodcone | Color Space | Bit Size | Channels |
| 1-bit, white | Etheral | OneBitBlack | 1 | 1 |
| background | | | | |
| 1-bit, black | Theral | OneBitBlack | 1 | 1 |
| background | | | | |
| Gray | Etheral | Gray | 1, 2, 4, 8, 16, | 1 |
| | | | . . . | |
| Color Mapped | IdColor | RGB, BGR, | 1, 2, 4, 8, 16, | 3 |
| | | RGBA, ABGR, | . . . | |
| | | CMYK, LAB, | | |
| | | and so on | | |
| Color | Color | RGB, BGR, | 1, 2, 4, 8, 16, | 3, 4 |
| | | RGBA, ABGR, | . . . | |
| | | CMYK, LAB, | | |
| | | and so on | | |
| MultiSpectral | Spectral | / | 1, 2, 4, 8, 16, | n |
| | | | . . . | |

The data file includes a header and a list of data blocks referred to as image tiles or extents. At this level, the data blocks comprise a linear set of bytes. 2-D, 3-D, or other semantics are added by an application layer. The data blocks are not necessarily related to physical device blocks. Rather, their size is generally selected to optimize device access speed. The data blocks are the unit of data access and, when possible, are retrieved in a single operation or access from the disk.

The header may be in one of two formats, one format based on 32-bit file offsets and another format based on 64-bit file offsets (for file sizes larger than 2 GB). The header, in one implementation, is 2048 bytes in size such that it aligns with the common secondary-storage physical block sizes (e.g., for a magnetic disk, 512 bytes, and for a CD-ROM, 2048 bytes). The two formats are presented below in Tables 3 and 4:

TABLE 3
Node data file header
32-bit file offsets

| | |
|---|---|
| Byte 0-28 | “<ExtentDataFile/LSP-DI-EPFL>\0” |
| Byte 29-42 | “Version 01.00\0” |
| Byte 43-47 | Padding (0) |
| Byte 48-51 | Endian Code |
| Byte 52-55 | Extent File Index |
| Byte 56-59 | Stripe Factor |
| Byte 60-63 | Start Extent Data Position |
| Byte 64-67 | End Extent Data Position |
| Byte 68-71 | Start Hole List Position |
| Byte 72-2047 | Padding |

TABLE 4
Node data file header
64-bit offsets

| | |
|---|---|
| Byte 0-28 | “<ExtentDataFile/LSP-DI-EPFL>\0” |
| Byte 29-42 | “Version 02.00\0” |
| Byte 43-47 | Padding (0) |
| Byte 48-51 | Endian Code |
| Byte 52-55 | Node Index |
| Byte 56-59 | Number of nodes |
| Byte 60-67 | Start Extent Data Position |
| Byte 68-75 | End Extent Data Position |
| Byte 76-83 | Start Hole List Position |
| Byte 84-2047 | Padding |

For both formats, bytes 48-51 represent the Endian code. The Endian code may be defined elsewhere as an enumerated type, for example, basBigEndian=0, basLiftleEndian=1. Bytes 52-55 represent the AXS file node index (Endian encoded as specified by bytes 48-51). Bytes 56-59 represent the number of nodes in the multi-resolution representation 120.

Start and End Extent Data Position represent the address of the first and last data bytes in the multi-resolution representation 120. The Start Hole List Position is the address of the first deleted block in the file. Deleted blocks form a linked list, with the first 4-bytes (for version 1) or 8-bytes (for version 2) in the block indicating the address of the next deleted data block (or extent). The next 4 bytes indicate the size of the deleted block. When there are no deleted blocks, the Start Hole List Position is zero.

Each data block comprises a header and a body (that contains the data block bytes). In one embodiment, the data block size is rounded to 2048 bytes to meet the physical-block size of most secondary storage devices. The semantics given to the header and the body is left open to the application developer.

The information used to access the data blocks is stored in the node address file. Typically, only the blocks that actually contain data are written to disk. The other blocks are assumed to contain by default NULL bytes (0). Their size is derived by the application layer.

The address file comprises a header and a list of block addresses. One version of the header (shown in Table 5) is used for 32-bit file offsets, while a second version of the header (shown in Table 6) is used for 64-bit file offsets (for file sizes larger than 2 GB). The header, in one implementation, is 2048 bytes in size to align with the most common secondary storage physical block sizes.

TABLE 5
Address data file header
32-bit offsets

| | |
|---|---|
| Byte 0-36 | “<ExtentAddressTableFile/LSP-DI- |
| | EPFL>\0” |
| Byte 37-50 | “Version 01.00\0” |
| Byte 51-55 | Padding (0) |
| Byte 56-59 | Endian Code |
| Byte 60-63 | Extent File Index |
| Byte 64-67 | Stripe Factor |
| Byte 68-71 | Extent Address Table Position |
| Byte 72-75 | Extent Address Table Size |
| Byte 76-79 | Last Extent Index Written |
| Byte 80-2047 | Padding |

TABLE 6
Address data file header
64-bit offsets

| | |
|---|---|
| Byte 0-36 | “<ExtentAddressTableFile/LSP-DI- |
| | EPFL>\0” |
| Byte 37-50 | “Version 02.00\0” |
| Byte 51-55 | Padding (0) |
| Byte 56-59 | Endian Code |
| Byte 60-63 | Extent File Index |
| Byte 64-67 | Stripe Factor |
| Byte 68-71 | Extent Address Table Position |
| Byte 72-75 | Extent Address Table Size |
| Byte 76-79 | Last Extent Index Written |
| Byte 80-2047 | Padding |

For both formats, bytes 56-59 represent the Endian code. The Endian code may be defined elsewhere as an enumerated type, for example, basBigEndian=0, basLittleEndian=1. Bytes 60-63 represent the AXS file node index (Endian encoded as specified by bytes 48-51). Bytes 64-67 represent the number of nodes in the multi-resolution representation 120. Bytes 68-71 represent the offset in the file of the block address table. Bytes 72-75 represent the total block address table size. Bytes 76-69 represent the las block address actually written.

Note that the block addresses are read and written from disk in 32 KByte chunks representing 1024 block addresses (version 1) and 512 block addresses (version 2).

A block address comprises the following information shown in Tables 7 and 8:

TABLE 7
Block address information (version 1)

| | |
|---|---|
| Bytes 0-3 | Block header position |
| Bytes 4-7 | Block header size |
| Bytes 8-11 | Block body size |
| Bytes 12-15 | Block original size |

TABLE 8
Block address information (version 2)

| | |
|---|---|
| Bytes 0-7 | Block header position |
| Bytes 8-11 | Block header size |
| Bytes 12-15 | Block body size |
| Bytes 16-19 | Block original size |
| Bytes 20-31 | padding |

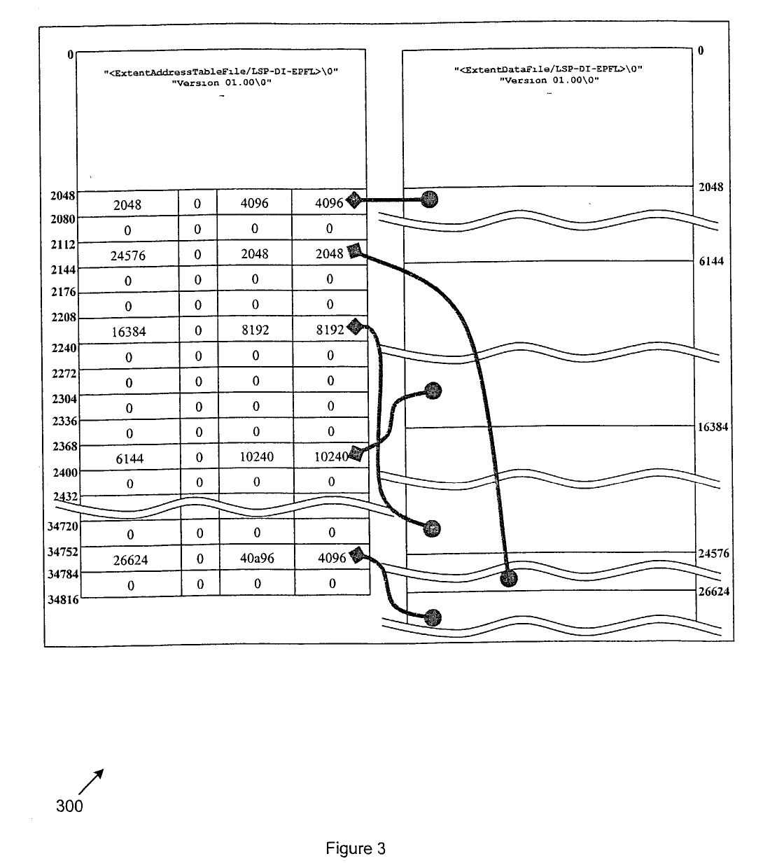

Turning to FIG. 3, that figure shows an example 300 of a multi-resolution representation 120 in which five blocks have been written in the following order: 1) The block with index 0 (located in the address file at offset 2048) has been written in the data file at address 2048. Its size is 4096 bytes. 2) The block with index 10 (located in the address file at offset 2368) has been written in the data file at address 6144. Its size is 10240 bytes. 3) The block with index 5 (located in the address file at offset 2208) has been written in the data file at address 16384. Its size is 8192 bytes. 4) The block with index 2 (located in the address file at offset 2112) has been written in the data file at address 24576. Its size is 2048 bytes. 5) The block with index 1022 (located in the address file at offset 34752) has been written in the data file at address 26624. Its size is 4096 bytes

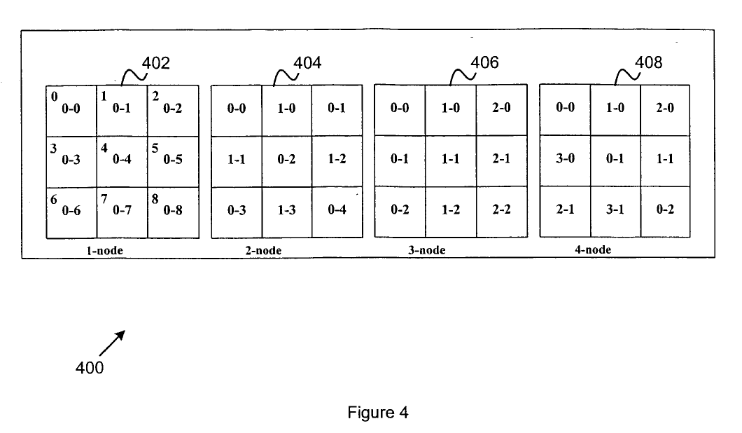

With regard to FIG. 4, that figure shows an example of a node/block index allocation for a 1, 2, 3, 4-node file comprising 3×3 image tiles. Assuming that the 2-D tiles are numbered line-by-line in the sequence shown in the upper left hand corner of the leftmost 3×3 set of image tiles 402, then: 1) in the case of a 1-node multi-resolution representation 120, all tiles are allocated to node 0, and block indices equal the tile indices, as shown in the leftmost diagram 402; 2) in the case of a 2-node multi-resolution representation 120, tiles are allocated in round-robin fashion to each node, producing the indexing scheme presented in the second diagram from the left; 3) in the case of a 3-node multi-resolution representation 120, tiles are allocated in round-robin fashion to each node, producing the indexing scheme presented in the second diagram from the right; 4) in the case of a 4-node multi-resolution representation 120, tiles are allocated in round-robin fashion to each node, producing the indexing scheme presented in the rightmost diagram.

The general formula for deriving node- and block-indices from tile indices is: NodeIndex=TileIndex mod NumberOfNodes, Blockindex=TileIndex div NumberOfNodes.

Referring again to FIG. 2, the distribution may be performed as described in U.S. Pat. No. 5,737,549. Furthermore, the image tiles (or original image in base format) may be color coded according to a selected color coding format either before or after the resolution representation 120 is generated or before of after the multi-resolution representation 120 is distributed across multiple disks. (Step 206). As noted above, the multi-resolution representation 120 may be distributed across multiple disks to enhance access speed. (Step 208).

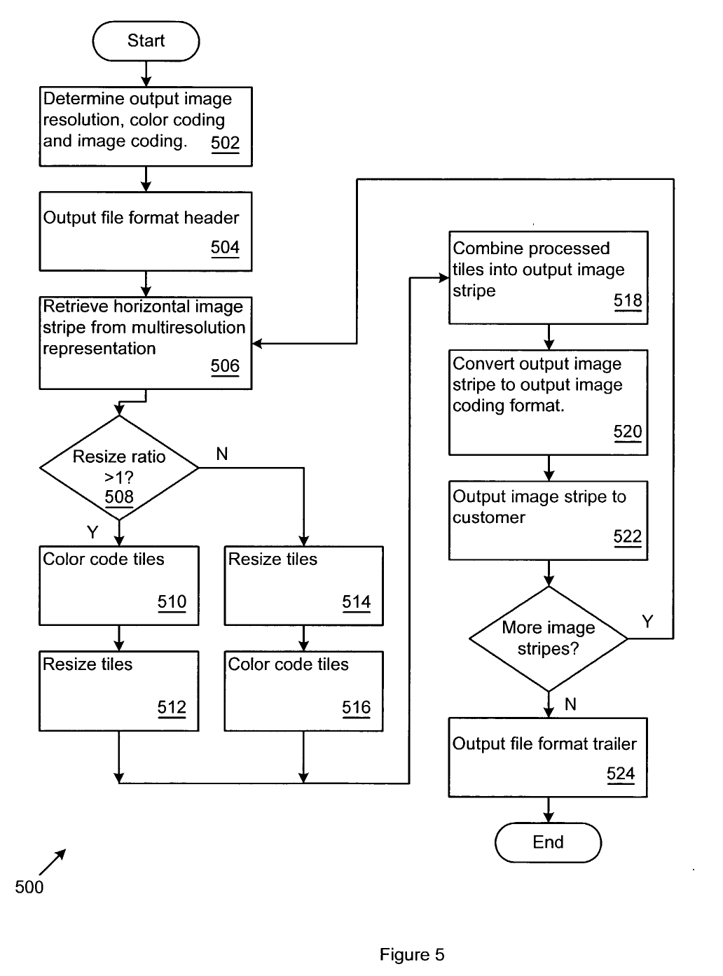

Turning to FIG. 5, that figure presents a flow diagram 500 of the processing that occurs when the image generation program 116 dynamically produces the output image 118. The image generation program 116 first determines output parameters including an output image resolution, size, an output color coding format, and an output image coding format (Step 502). As an example, the image generation program 116 may determine the output parameters based on a customer request received at the image processing system 100. For instance, the image generation program 116 may receive a message that requests that a version of an original image be delivered to the customer at a specified resolution, color coding format, and image coding format.

Optionally, the image generation program 116 may determine or adjust the output parameters based on a customer connection bandwidth associated with a communication channel from the image processing system 100 to the customer. Thus, for example, when the communication channel is a high speed Ethernet connection, then the image generation program 116 may deliver the output image at the full specified resolution, color coding, and image coding. On the other hand, when the communication channel is a slower connection (e.g., a serial connection) then the image generation program 116 may reduce the output resolution, or change the color coding or image coding to a format that results in a smaller output image. For example, the resolution may be decreased, and the image coding may be changed from a non-compressed format (e.g., bitmap) to a compressed format (e.g., jpeg), or from a compressed format with a first compression ratio to the same compressed format with a greater compression ratio (e.g., by increasing the jpeg compression parameter), so that the resultant output image has a size that allows it to be transmitted to the customer in less than a preselected time.

Referring again to FIG. 2, once the output parameters are determined, the image generation program 116 outputs a header (if any) for the selected image coding format. (Step 504). For example, the image generation program 116 may output the header information for the jpeg file format, given the output parameters. Next, the image generation program 116 generates the output image 118.

The image generation program 116 dynamically generates the output image 118 starting with a selected image entry in the multi-resolution representation 120 of the original image. To that end, the image generation program 116 selects an image entry based on the desired output image resolution. For example, when the multi-resolution representation 120 includes an image entry at exactly the desired output resolution, the image generation program 116 typically selects that image entry to process to dynamically generate the output image. In many instances, however, the multi-resolution representation 120 will not include an image entry at exactly the output resolution.

As a result, the image generation program 116 will instead select an image entry that is near in resolution to the desired output image resolution. For example, the image generation program 116 may, if output image quality is critical, select an image entry having a starting resolution that is greater in resolution (either in x-dimension, y-dimension, or both) than the desired output image resolution. Alternatively, the image generation program 116 may, if faster processing is desired, select an image entry having a starting resolution that is smaller in resolution (either in x-dimension, y-dimension, or both) than the output resolution.

If the selected image entry does not have the desired output image resolution, then the image generation program 116 applies a resizing technique on the image data in the selected image entry so that the output image will have the desired output image resolution. The resize ratio is the ratio of the output image size to the starting image size (i.e., the size of the selected image entry). The resize ratio is greater than one when then selected version will be enlarged, and less than one when the selected version will be reduced. Note that generally, the selected image entry in the multi-resolution representation 120 is not itself changed. However, the resizing is applied to image data in the selected image entry.

The resizing operation may be implemented in many ways. For example, the resizing operation may be a bi-linear interpolation resampling, or pixel duplication or elimination. In one embodiment, the image tiles are resampled in accordance with the techniques set forth in U.S. patent application Ser. No. ______, filed ______, titled “Parallel Resampling of Image Data”, the entirety of which is incorporated herein by reference.

In carrying out the resizing operation, the image generation program 116 retrieves an image stripe from the selected image entry. (Step 506). As noted above, the image stripe is composed of image tiles that horizontally span the image entry.

If the resize ratio is greater than one (Step 508), then the image generation program 116 color codes the image tiles in the image stripe to meet the output color coding format. (Step 510). Subsequently, the image generation program 116 resizes the image tiles to the output resolution. (Step 512).

Alternatively, if the resize ratio is less than one, then the image generation program 116 first resizes the image tiles to the output resolution. (Step 514). Subsequently, the image generation program 116 color codes the image tiles to meet the output color coding format. (Step 516).

The image tiles, after color coding and resizing, are combined into an output image stripe. (Step 518). The output image stripes are then converted to the output image coding format (Step 520). For example, the output image stripes may be converted from bitmap format to jpeg format. While the image generation program 116 may include the code necessary to accomplish the output image coding, the image generation program 116 may instead execute a function call a supporting plug-in module. Thus, by adding plug-in modules, the image coding capabilities of the image generation program 116 may be extended.

Subsequently, the converted output image stripes are transmitted to the customer. (Step 522). After the last output image stripe has been transmitted, the image generation program 116 outputs the file format trailer (if any). (Step 524). Note that image generation program 116, in accordance with certain image coding formats (for example, tiff) may instead output a header at Step 524.

The multi-resolution representation 120 stores the image entries in a preselected image coding format and color coding format. Thus, when the output parameters specify the same color coding, image coding, size, or resolution as the image entry, the image generation program 116 need not execute the color coding, image coding, or resizing steps described above.

The steps 206-220 may occur in parallel across multiple CPUs, multiple image processing systems 100, 132-138, and multiple instances of the image generation program 116. Furthermore, the image generation program 116 typically issues command to load the next image stripe while processing is occurring on the image tiles in a previous image stripe.

Note that a plug-in library may also be provided in the image processing system 100 to convert an image entry back into the original image. To that end, the image processing system 100 generally proceeds as shown in FIG. 5, except that the starting image is generally the highest resolution image entry stored in the multi-resolution representation 120.

Note also that as each customer request for an output image is fulfilled, the image generation program 116 may store in the output image in a cache or other memory. The cache, for example, may be indexed by a “resize string” formed from an identification of the original image and the output parameters for resolution, color coding and image coding. Thus, prior to generating an output image from scratch, the image generation program 116 may instead search the cache to determine if the requested output image has already been generated. If so, the image generation program 116 retrieves the output image from the cache and sends it to the customer instead or re-generating the output image.

Color coding is generally, though not necessarily, performed on the smallest set of image data in order to minimize computation time for obtaining the requested color coding. As a result, when the resampling ratio is greater than one, color coding is performed before resizing. However, when the resampling ratio is less than one, the resizing is performed before color coding.

Tables 9 and 10 show a high level presentation of the image generation steps performed by the image generation program 116.

TABLE 9
For a resize ratio that is greater than one

Output file format header
For each horizontal image stripe

In parallel for each tile in the image stripe

color code tile
resize color coded tile
assemble resampled color coded tile into image stripe

output horizontal image stripe

output file format trailer

TABLE 10
For a resize ratio that is less than one

Output file format header
For each horizontal image stripe

In parallel for each tile in the image stripe

resize tile
color code resized tile
assemble resampled color coded tile into image stripe

output horizontal image stripe

output file format trailer

The image generation technique described above has numerous advantages. A single multi-resolution representation 120 may be used in multiple applications that need to dynamically generate different output image sizes, resolutions, color coding and image coding formats. Thus, only one file need be managed for use in multiple applications, with each desired image dynamically generated upon client request from the multi-resolution representation 120. Storing the image entries as image tiles allows the image generation program 116 to use the high performance resizing technique referred to above in the co-pending patent application. Furthermore, the format of the multi-resolution representation allows the original image to be reconstructed, if needed.

The image generation program 116 also provides a self-contained “kernel” that can be called through an Application Programming Interface. As a result, any third party application can call the kernel with a selected output image size, resolution, color coding and image coding format. Because the color coding format can be specified, the image generation program 116 can dynamically generate images in the appropriate format for many types of output devices, ranging from black and white for a handheld or palm device to full color RGB for a display or web browser output. Image coding plug-in modules allow the image generation program 116 to grow to support a wide range of image coding formats.

A relationship exists between image size and image resolution, and the number of pixels in an image. In particular, an image has a width and a height measured in pixels (given, for example, by the parameters pixel-width and pixel-height). An image is output (e.g., printed or displayed) at a requested width and height measured in inches or another unit of distance (given, for example, by the parameters physical-width and physical-height). The output device is characterized by an output resolution typically given in dots or pixels per inch (given, for example, by the parameters horizontal-resolution and vertical-resolution). Thus, pixel-width=physical-width * horizontal-resolution and pixel-height=physical-height*vertical-resolution. A dynamically generated output image may be generated to match any specified physical-width and physical-height by resampling a staring image to increase the number of pixels horizontally or vertically.

Thus, the image generation techniques described above allow customers to use images that were previously considered too large and cumbersome for modern data processing systems to handle. Furthermore, the data representing the images is handled directly from secondary storage without having to load the entire data into memory. Similarly, portions of the data may be served over narrow bandwidth communication channels without having to transfer the entirety of the data to the customer.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. As one example, different types of multi-resolution representations may be used (e.g., Flashpix or JPEG2000) to dynamically generate output images. Additionally, the described implementation includes software but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method in an image processing system for image generation, the method comprising the steps of:
determining an output image resolution and output image coding format;
based on the output image resolution, selecting a starting image resolution from a multi-resolution representation of an image;
retrieving image data characterized by a starting image coding format, a starting color coding format, and a starting image resolution from the multi-resolution representation;
resizing the image data to the output image resolution; and
when the output image coding format is different than the starting image coding format, converting the image data to the output image coding format.

2. The method of claim 1, further comprising the steps of:
determining an output color coding format; and
when the output color coding format is different than the starting color coding format, converting the image data to the output color coding format.

3. The method of claim 1, wherein the retrieving step comprises retrieving an image stripe comprising image tiles from the multi-resolution representation.

4. The method of claim 3, wherein the resizing step comprises resizing at least two of the image tiles in parallel.

5. The method of claim 3, wherein, when the output image resolution is not present in the multi-resolution representation, the selecting step selects the nearest larger resolution as the starting image resolution.

6. The method of claim 3, wherein, when the output image resolution is not present in the multi-resolution representation, the selecting step selects the nearest smaller resolution as the starting image resolution.

7. The method of claim 2, wherein the retrieving step comprises retrieving an image stripe comprising image tiles from the multi-resolution representation, and wherein the step of converting the image data to the output color coding format comprises converting at least two of the image tiles in parallel.

8. The method of claim 1, wherein the step of determining an output image resolution comprises determining the output image resolution based on a customer connection bandwidth.

9. The method of claim 2, wherein, when the output image resolution is greater than the starting image resolution, the step of converting the image data to the output color coding format precedes the step of resizing the image data to the output image resolution.

10. The method of claim 2, wherein, when the output image resolution is less than the starting image resolution, the step of converting the image data to the output color coding format follows the step of resizing the image data to the output image resolution.

11. The method of claim 1, further comprising the step of storing an input image in the multi-resolution representation.

12. The method of claim 11, further comprising the step of color coding the input image according to the starting color coding format.

13. The method of claim 1, further comprising the step of storing an input image as image tiles in the multi-resolution representation.

14. The method of claim 13, wherein storing comprises storing the image tiles across multiple disks.

15. A machine-readable medium storing instructions that cause a data processing system to perform a method for image generation, the method comprising the steps of:
determining an output image resolution and output image coding format;
based on the output image resolution, selecting a starting image resolution from a multi-resolution representation of an image;
retrieving image data characterized by a starting image coding format, a starting color coding format, and a starting image resolution from the multi-resolution representation;
resizing the image data to the output image resolution; and
when the output image coding format is different than the starting image coding format, converting the image data to the output image coding format.

16. The method of claim 15, further comprising the steps of:
determining an output color coding format; and
when the output color coding format is different than the starting color coding format, converting the image data to the output color coding format.

17. The method of claim 15, wherein the retrieving step comprises retrieving an image stripe comprising image tiles from the multi-resolution representation.

18. The method of claim 17, wherein the resizing step comprises resizing at least two of the image tiles in parallel.

19. The method of claim 15, wherein the step of determining an output image resolution comprises determining the output image resolution based on a customer connection bandwidth.

20. The method of claim 15, further comprising the step of storing an input image as image tiles in the multi-resolution representation.

21. The method of claim 20, wherein storing comprises the step of storing the image tiles across multiple disks.

22. An image processing system comprising:
a memory storing an image generation program, the image generation program generating at least a portion of an output image characterized by an output image resolution and an output image coding format by, based on the output image resolution, selecting a starting image resolution from a multi-resolution representation of an image, retrieving image data characterized by a starting image coding format, a starting color coding format, and a starting image resolution from the multi-resolution representation, resizing the image data to the output image resolution, and when the output image coding format is different than the starting image coding format, converting the image data to the output image coding format; and
a processor that runs the image serving program.

23. The image processing system of claim 22, wherein the image data comprises an image stripe comprising image tiles.

24. The image processing system of claim 23, wherien the image serving program resizes at least two of the image tiles in parallel.

25. The image processing system of claim 23, wherein the image serving program converts at least two of the image tiles in parallel to the output image coding format.

26. The image processing system of claim 23, wherein the image serving program converts at least two image tiles in parallel to a selected output color coding format.

27. The image processing system of claim 22, wherein the output image resolution is determined according to a customer connection bandwidth.

28. The image processing system of claim 23, wherein each image tile has an amount of image data approximately equal to T * L, where T is a throughput of the disk that stores the image tile, and L is a latency of the disk that stores the image tile.

29. An image processing system comprising:
a memory comprisng an image generation program generating at least a portion of an output image characterized by an output image resolution and an output image coding format by, based on the output image resolution, selecting a starting image resolution from a multi-resolution representation of an image, retrieving image data characterized by a starting image coding format, a starting color coding format, and a starting image resolution from the multi-resolution representation, resizing the image data to the output image resolution, and when the output image coding format is different than the starting image coding format, converting the image data to the output image coding format;
a plurality of disks, each disk storing a portion of the multi-resolution representation; and
a plurality of processors for executing selected image serving processing steps in parallel.

30. The image processing system of claim 29, wherein the image data comprises an image stripe comprising image tiles.

31. The image processing system of claim 30, wherien the image serving processing steps include resizing the image tiles in parallel.

32. The image processing system of claim 30, wherein the image serving processing steps include color coding the image tiles in parallel.

33. The image processing system of claim 30, wherein the image serving program sends the output image to a customer as resized re-color coded image stripes.

34. The image processing system of claim 30, wherein the image serving program outputs an output image coding format header, followed by resized re-color coded image stripes.

35. The image processing system of claim 34, wherein the image serving program outputs an output image coding format trailer after the resized re-color coded image stripes.

36. The image processing system of claim 30, wherein each image tile has an amount of image data approximately equal to T*L, where T is a throughput of the disk that stores the image tile, and L is a latency of the disk that stores the image tile.

37. A machine-readable medium storing instructions that cause a data processing system to perform a method for image generation, the method comprising the steps of:
means for determining an output image resolution and output image coding format;
means for selecting a starting image resolution from a multi-resolution representation of an image based on the output image resolution;
means for retrieving image data characterized by a starting image coding format, a starting color coding format, and a starting image resolution from the multi-resolution representation;
means for resizing the image data to the output image resolution; and
means for converting the image data to the output image coding format when the output image coding format is different than the starting image coding format.
